(19) United States
(12) Patent Application Publication
(10) Pub. No.: US 2016/0299910 A1
(43) Pub. Date: Oct. 13, 2016

(54) METHOD AND SYSTEM FOR QUERYING AND VISUALIZING SATELLITE DATA

(71) Applicant: Umm Al-Qura University, Makkah (SA)

(72) Inventors: Mohamed MOKBEL, New Brighton, MN (US); Sohaib Ghani, Makkah (SA); Ahmed Eldawy, Makkah (SA)

(73) Assignee: Umm Al-Qura University, Makkah (SA)

(21) Appl. No.: 15/055,124

(22) Filed: Feb. 26, 2016

Related U.S. Application Data
(60) Provisional application No. 62/145,366, filed on Apr. 9, 2015.

(51) Int. Cl. G06F 17/30

(52) U.S. Cl. CPC G06F 17/3087; G06F 17/30241; G06F 17/30554

(57) ABSTRACT

Aspects of the disclosure provide a method of satellite data service. The method includes receiving a dataset of values that are measurements of a parameter at a temporal point for locations on the earth, organizing the values according to spatial layers in an aggregate spatio-temporal index system to form an aggregate tree associated with the temporal point, and updating temporal layers in the aggregate spatio-temporal index system in response to the aggregate tree. Further, the method includes receiving a query specifying the parameter, a temporal range and a spatial range, filtering, according to the aggregate spatio-temporal index system, in the temporal layers and the spatial layers to select aggregate nodes, and generating an answer to the query based on the selected aggregate nodes.

### INCORPORATION BY REFERENCE

This present disclosure claims the benefit of U.S. Provisional Application No. 62/145,366, “SHAHED: A MAPREDUCE-BASED SYSTEM FOR QUERYING AND VISUALIZING LARGE SPATIO-TEMPORAL SATELLITE DATA” filed on Apr. 9, 2015, which is incorporated herein by reference in its entirety.

### BACKGROUND

Several space agencies, such as National Aeronautics and Space Administration (NASA) are continuously collecting data of earth dynamics, e.g., temperature, vegetation, cloud coverage, and the like through satellites. This data is stored in a publicly available archive for scientists and researchers and is very useful for studying climate, desertification, and land use change. The benefit of this data comes from its richness as it provides an archived history for over 15 years of satellite observations.

### SUMMARY

Aspects of the disclosure provide a method of satellite data service. The method includes receiving a dataset of values that are measurements of a parameter at a temporal point for locations on the earth, organizing the values according to spatial layers in an aggregate spatio-temporal index system to form an aggregate tree associated with the temporal point, and updating temporal layers in the aggregate spatio-temporal index system in response to the aggregate tree.

To receive the dataset of values that are the measurements of the parameters at the temporal point for the locations on the earth, in an example, the method includes estimating a missing value for a location in the dataset based on values of other locations.

To estimate the missing value for the location in the database, in an example, the method includes calculating a first estimate for the location based on first values of first other locations aligned with the location in a first dimension, calculating a second estimate for the location based on second values of second other locations aligned with the location in a second dimension, and combining the first estimate and the second estimate to calculate the missing value.

To organize the values according to the spatial layers in the aggregate spatio-temporal index system to form the aggregate tree associated with the temporal point, in an example, the method includes organizing the values as leaf nodes in the aggregate tree that uses a quad tree data structure for indexing a two-dimensional space, and assigning aggregated values from child nodes of each aggregate node to the aggregate node.

To update the temporal layers in the aggregate spatio-temporal index system in response to the aggregate tree, the method includes adding the aggregate tree as a daily node in a daily layer of the aggregate spatio-temporal index system. Further, the method includes adding a monthly aggregate tree as a monthly node in a monthly layer of the aggregate spatio-temporal index system to aggregate daily nodes in a month when the daily nodes in the month are complete. In addition, the method can include adding a yearly aggregate tree as a yearly node in a yearly layer of the aggregate spatio-temporal index system to aggregate monthly nodes in a year when the monthly nodes of the year are complete.

Aspects of the disclosure provide another method of satellite data service. The method includes storing satellite datasets of values that are measurements of a parameter over time for locations on the earth according to an aggregate spatio-temporal index system with aggregate nodes that aggregate the satellite datasets in temporal layers and spatial layers, receiving a query specifying the parameter, a temporal range and a spatial range, filtering, according to the aggregate spatio-temporal index system, in the temporal layers and the spatial layers to select aggregate nodes, and generating an answer to the query based on the selected aggregate nodes.

To store the satellite datasets of values that are measurements of the parameter over time for the locations on the earth according to the aggregate spatio-temporal index system with the aggregate nodes that aggregate the satellite datasets in the temporal layers and the spatial layers, the method includes storing a dataset of values for the parameter associated with a temporal point as leaf nodes in an aggregate tree that uses a quad tree data structure for indexing a two-dimensional space. Further, the method includes storing the aggregate tree associated with the temporal point as a daily node in a daily layer of the aggregate spatio-temporal index system. In addition, the method includes storing a monthly aggregate tree as a monthly node in a monthly layer of the aggregate spatio-temporal index system to aggregate daily nodes in a month. Then, the method includes storing a yearly aggregate tree as a yearly node in a yearly layer of the aggregate spatio-temporal index system to aggregate monthly nodes in a year.

To filter, according to the aggregate spatio-temporal index system, in the temporal layers and the spatial layers to select the aggregate nodes, in an example, the method includes filtering by the temporal layers to select aggregate trees that are in the temporal range, filtering by the spatial layers to select values in the aggregate trees that are in the spatial range, and forming the answer to the query from the selected values. In another example, the method includes filtering by the temporal layers to select aggregate trees that are in the temporal range, filtering by the spatial layers to select aggregate nodes that are in the temporal range and aggregating the selected aggregate nodes to form the answer to the query.

To generate the answer to the query based on the selected aggregate nodes, the method includes generating visual media to represent the answer. To generate the visual media to represent the answer, the method includes at least one of generating an image to represent the answer, generating a series of images to form a video, and generating multi-level images.

Aspects of the disclosure provide a satellite data server system that includes memory circuitry and processing circuitry. The memory circuitry is configured to store satellite data for a parameter according to an aggregate spatio-temporal index system. The processing circuitry is configured to receive a dataset of values that are measurements of the parameter at a temporal point for locations on the earth, organize the values according to spatial layers in the aggregate spatio-temporal index system to form an aggregate tree associated with the temporal point, and update temporal layers in the aggregate spatio-temporal index system to add the aggregate tree in the stored satellite data.

According to an aspect of the disclosure, the processing circuitry is configured to estimate a missing value for a location in the dataset based on values of other locations. In an example, the processing circuitry is configured to calculate a first estimate for the location based on first values of first other locations aligned with the location in a first dimension, calculate a second estimate for the location based on second values of second other locations aligned with the location in a second dimension and combine the first estimate and the second estimate to calculate the missing value.

In an embodiment, the processing circuitry is configured to organize the values as leaf nodes in the aggregate tree that uses a quad tree data structure for indexing a two-dimensional space and assign aggregated values from child nodes of each aggregate node to the aggregate node. In an example, the processing circuitry is configured to add the aggregate tree as a daily node in a daily layer of the aggregate spatio-temporal index system. Further, the processing circuitry is configured to add a monthly aggregate tree as a monthly node in a monthly layer of the aggregate spatio-temporal index system to aggregate daily nodes in a month when the daily nodes of the month are complete, and add a yearly aggregate tree as a yearly node in a yearly layer of the aggregate spatio-temporal index system to aggregate monthly nodes in a year when the monthly nodes are complete.

Aspects of the disclosure provide another satellite data server system that includes memory circuitry and processing circuitry. The memory circuitry is configured to store satellite data for a parameter according to an aggregate spatio-temporal index system. The processing circuitry is configured to receive a dataset of values that are measurements of the parameter at a temporal point for locations on the earth, organize the values according to spatial layers in the aggregate spatio-temporal index system to form an aggregate tree associated with the temporal point, and update temporal layers in the aggregate spatio-temporal index system to add the aggregate tree in the stored satellite data.

According to an aspect of the disclosure, the memory circuitry is configured to store a dataset of values for the parameter associated with a temporal point as leaf nodes in an aggregate tree that uses a quad tree data structure for indexing a two-dimensional space.

In an embodiment, the memory circuitry is configured to store the aggregate tree associated with the temporal point as a daily node in a daily layer of the aggregate spatio-temporal index system. In addition, in an example, the memory circuitry is configured to store a monthly aggregate tree as a monthly node in a monthly layer of the aggregate spatio-temporal index system to aggregate daily nodes in a month. Further, the memory circuitry is configured to store a yearly aggregate tree as a yearly node in a yearly layer of the aggregate spatio-temporal index system to aggregate monthly nodes in a year.

According to an aspect of the disclosure, the processing circuitry is configured to filter by the temporal layers to select aggregate trees that are in the temporal range, filter by the spatial layers to select values in the aggregate trees that are in the spatial range, and forming the answer to the query from the selected values.

Further, in an example, the processing circuitry is configured to filter by the temporal layers to select aggregate trees that are in the temporal range, filter by the spatial layers to select aggregate nodes that are in the temporal range, and aggregate the selected aggregate nodes to form the answer to the query. In an embodiment, the processing circuitry is configured to generate at least one of an image, a series of images, multi-level images to represent the answer.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a diagram of a system according to an embodiment of the disclosure;

FIG. 2 shows a tree structure according to an embodiment of the disclosure;

FIG. 3 shows a flow chart outlining a process example according to an embodiment of the disclosure;

FIG. 4 shows a flow chart outlining a process example according to an embodiment of the disclosure;

FIG. 5 shows a diagram for map images according to an embodiment of the disclosure;

FIG. 6 shows a graphic user interface (GUI) 600 according to an embodiment of the disclosure;

FIG. 7 shows a graphic user interface (GUI) 700 for a user to generate heat maps according to an embodiment of the disclosure;

FIG. 8 shows a heat map 800 generated by the satellite data server 130 according to an embodiment of the disclosure; and

FIG. 9 shows a graphic user interface (GUI) 900 according to an embodiment of the disclosure.

### DETAILED DESCRIPTION OF EMBODIMENTS

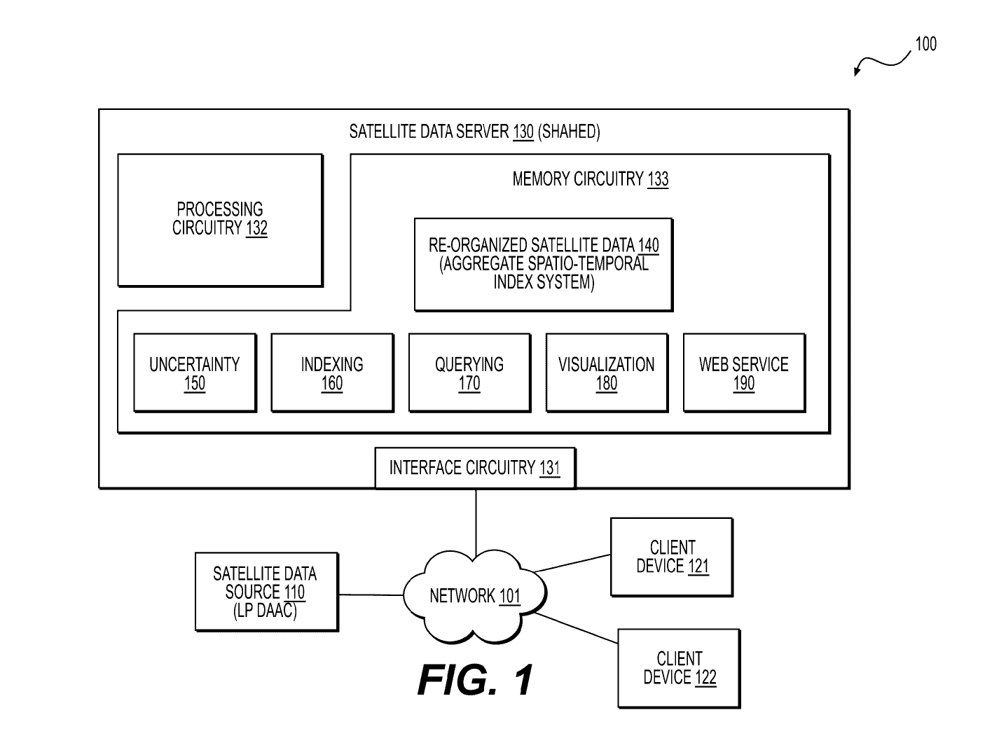

FIG. 1 shows a diagram of a system 100 according to an embodiment of the disclosure. The system 100 includes a satellite data server 130 configured to provide querying and visualizing satellite data service to users. The satellite data server 130 organizes satellite data according to an aggregate spatio-temporal index system to enable efficient querying and visualizing service.

The system 100 includes a network 101, the satellite data server 130, a satellite data source 110, and a plurality of client devices, such as client devices 121 and 122.

The network 101 can be wired, wireless, a local area network (LAN), a wireless LAN (WLAN), a fiber optical network, a wide area network (WAN), a peer-to-peer network, the Internet, etc. or any combination of these that interconnects the satellite data server 130 with the satellite data source 110 and the client devices 121-122. In an example, the network 101 includes a fiber optic network in connection with a cellular network. Further, the network 101 can be a data network or a telecommunication network or video distribution (e.g. cable, terrestrial broadcast, or satellite) network in connection with a data network. Any combination of telecommunications, video/audio distribution and data networks, whether a global, national, regional, wide-area, local area, or in-home network, can be used without departing from the spirit and scope of the disclosure.

The satellite data source 110 can be provided by one or more space agencies. Space agencies, such as National Aeronautics and Space Administration (NASA), continuously collect data of earth dynamics, e.g., temperature, vegetation, cloud coverage, and the like through satellites. In an example, the collected data is stored in a publicly available archive for scientists and researchers and is very useful for studying climate, desertification, and land use change. For example, over 15 years of satellite observations can be provided to provide an archived history.

In an example, NASA uses satellites orbiting the earth to remotely collect datasets that measure earth physical phenomena including land temperature, vegetation, thermal anomalies and the like, and makes the satellite collected datasets public available for use through the Land Process Distributed Active Archive Center (LP DAAC) 110. For example, the LP DAAC 110 includes huge amount of satellite collected data, such as over 500 TB, and the data is increasing in a daily manner. The satellite collected data is useful in many applications and research areas, such as land cover change, detection of desertification, and climate informatics.

The satellite data server 130 downloads data from the satellite data source 110, and re-organizes the data according to an aggregate spatio-temporal index system to enable efficient querying and visualizing service. Further, the satellite data service 130 receives queries from the client devices 121-122, and provides visualized responses based on the aggregate spatio-temporal index system.

The client devices 121-122 can be any suitable devices, such as computers, desktop computers, laptop computers, tablet computers, smart phones, and the like. In an example, the client device 121 is a computer with a client software installed. The computer executes the client software to provide a user interface for a user to generate queries. Further, the computer executes the client software to send the queries to the satellite data server 130, to receive visualized responses from the satellite data server 130, and to generate graphic interface showing the results of the queries.

It is noted that the satellite data server 130 can be formed by any suitable web server technology. In the FIG. 1 example, the satellite data server 130 includes interface circuitry 131, processing circuitry 132, and memory circuitry 133.

The interface circuitry 131 is suitably configured to receive incoming signals from the network 101 and transmit outgoing signals to the network 101 according to suitable communication standards. The interface circuitry 131 can be implemented according to any suitable technology, such as Ethernet technology, WiFi technology, radio technology, and the like.

The memory circuitry 133 is configured to store software instructions and data, and the processing circuitry 132 is configured to execute the software instructions to process the data, and the processed data can be stored back to the memory circuitry 133. The memory circuitry 133 can be implemented using any suitable memory technology, such as solid state memory technology, hard disc drive technology, optical disc drive technology and the like. The processing circuitry 132 can be implemented using any suitable processing technology and architecture, such as a reduced instruction set computing (RISC) architecture, complex instruction set computing (CISC) architecture, a pipeline architecture, Acorn RISC Machine (ARM) architecture, and the like.

In an embodiment, the satellite data server 130 is implemented using distributed system. For example, the processing circuitry 132 includes multiple processing units connected through a network (not shown), and the memory circuitry 133 includes multiple memory units connected through the network.

According to an aspect of the disclosure, the memory circuitry 133 stores software instructions to re-organize the data according to an aggregate spatio-temporal index system to enable efficient querying and visualizing service. In the FIG. 1 example, the memory circuitry 133 stores software instructions of a uncertainty component 150, software instructions of an indexing component 160, software instructions of an querying component 170, software instructions of a visualization component 180, and software instructions of a web service component 190. In addition, the memory circuitry 133 stores the re-organized satellite data 140 according to the aggregate spatio-temporal index system.

The processing circuitry 132 is configured to execute the software instructions to perform functions of the uncertainty component 150 and functions of the indexing component 160 to receive satellite data and re-organize the satellite data according to the aggregate spatio-temporal index system. Further, the processing circuitry 132 is configured to execute the software instructions to perform the functions of the querying component 170, functions of the visualization component 180, and functions of the web service component 190 to receive queries, generate answers to queries based on the re-organized satellite data 140, and send the answers to the users.

According to an aspect of the disclosure, the uncertainty component 150 and the indexing component 160 form a data interface to process new data from the satellite data source 110 and add the new data in the re-organized satellite data 140 according to the aggregate spatio-temporal index system. For example, the uncertainty component 150 is configured to process newly downloaded data and use an interpolation technique, such as a two-dimensional interpolation technique and the like, to estimate missing data; and the indexing component 160 is configured to employ an indexing technique, such as the aggregate spatio-temporal index system, that re-organizes the new satellite data and adds the new satellite data into the re-organized satellite data 140. The re-organized satellite data 140 allows the satellite data server 130 to answer spatio-temporal queries efficiently.

Further, the querying component 170, the visualization component 180 and the web service component 190 from a user interface to respond to queries from the user based on the re-organized satellite data 140. For example, the querying component 170 is configured to use aggregate spatio-temporal index system and the re-organized satellite data 140 to answer both selection and aggregate queries for spatio-temporal in a real time manner. The visualization component 180 is configured to generate images, videos, multi-level images to represent the distribution of the satellite data over space and time and form the responses to the queries.

The web service component 190 is configured to enable communicate over a standard means, such as World Wide Web's (WWW) HyperText Transfer Protocol (HTTP), that is used to interoperate between software applications running on a variety of platforms and frameworks.

According to an aspect of the disclosure, original data collected by satellites has certain level of uncertainty. In an example, clouds can block the satellites sensors when the satellite images are taken, and cause missing data at random area. In another example, satellites mis-alignments can cause blind spots not covered by any of the satellite, and cause missing data at a sharp triangle-like area.

In an embodiment, the uncertainty component 150 uses a two-dimensional interpolation technique that estimates missing data based on nearby data points in the original satellite dataset. In an example, the uncertainty component 150 calculates a first estimate in a first dimension and a second estimate in a second dimension for each missing point, and suitably combines the first estimate and the second estimate. In an example, the uncertainty component 150 uses a linear interpolation function to calculate the first estimate based on the two closest points on the same latitude as the missing point, and uses a linear interpolation function to calculate the second estimate based on the two closest points on the same longitude as the missing point. Further, in an example, the uncertainty component 150 calculates an average of the first estimate and the second estimate, and uses the average as the final estimate for the missing point. In another example, when one of the first estimate and the second estimate is not available, the uncertainty component 150 uses the other estimate as the final estimate for the missing point. The final estimates are filled in the missing points of the original satellite dataset to form the satellite data for re-organization.

The indexing module 160 is configured to use the aggregate spatio-temporal index system to maintain the re-organized satellite data 140. In an embodiment, the aggregate spatio-temporal index system includes multiple temporal layers and multiple spatial layers with different resolutions. Satellite data is organized in the temporal layers and the spatial layers as nodes.

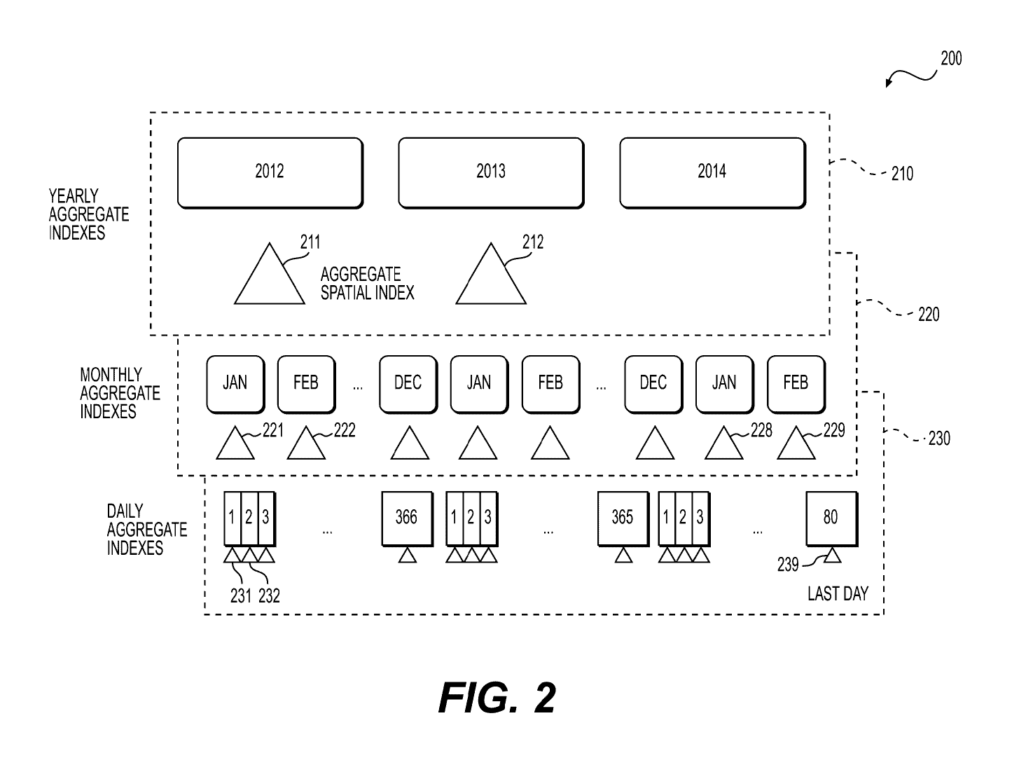

FIG. 2 shows a diagram of an aggregate spatio-temporal index system 200 for organizing the satellite data according to an embodiment of the disclosure. The aggregate spatio-temporal index system 200 includes two orthogonal hierarchies, a temporal hierarchy and a spatial hierarchy. In the temporal hierarchy, the aggregate spatio-temporal index system 200 has three temporal layers, a yearly layer 210, a monthly layer 220 and a daily layer 230. Each of the three layers includes a copy of the satellite data partitioned by a different temporal resolution. For example, the yearly layer 210 includes the satellite data partitioned at a yearly resolution, the monthly layer 220 includes a copy of the satellite data partitioned at a monthly resolution, and the daily layer 230 includes a copy of satellite data partitioned at a daily resolution. Each temporal layer includes nodes that are the partitions at the corresponding temporal resolution. For example, the yearly layer 210 includes yearly nodes 211-212 that are partitions in the yearly resolution; the monthly layer 220 includes monthly nodes 221-229 that are partitions in the monthly resolution; and the daily layer 230 includes daily nodes 231-239 that are partitions in the daily resolution.

According to an aspect of the disclosure, the indexing component 160 is configured to generate a temporal partition when the satellite data in the corresponding time frame is concluded. In FIG. 2 example, on the day of Mar. 22, 2014, the year 2013 is concluded, thus the yearly layer 210 includes a yearly node 212 for the year 2013. The yearly layer 210 also includes yearly nodes for years before 2013. Further, the month February, 2014 is concluded, thus the monthly layer 220 includes a monthly node 229 for the month February, 2014. The monthly layer 220 also includes monthly nodes for months before February, 2014. Also, the day Mar. 21, 2014 is concluded, thus the daily layer 230 includes a daily node 239 for Mar. 21, 2014. The daily layer 230 also includes daily nodes for days before Mar. 21, 2014.

Further, according to an aspect of the disclosure, each of the yearly nodes 211-212, monthly nodes 221-229 and daily nodes 231-239 are further indexed in the spatial hierarchy. In an embodiment, the aggregate spatio-temporal index system 240 uses an aggregate quad tree to index the satellite data in the spatial hierarchy. The aggregate quad tree includes leaf nodes and aggregate nodes. The leaf nodes are the data points from the satellite data, and are end nodes without child nodes. The aggregate nodes have child nodes and are built based on aggregate functions of the child nodes. The child nodes can be leaf nodes or other aggregate nodes.

In an example, the aggregate quad tree is built similar to quad tree in which each internal node has four child nodes. Each of the four child nodes is one of four quadrant partitions in a two dimensional space. In an example, the aggregate quad tree is built by recursively subdividing a two-dimensional space into four quadrants or regions until the child nodes are data points in the satellite data. In an example, each aggregate node is assigned with aggregate values that summarize nodes under the aggregate node. The aggregate values are calculated according to aggregate functions, such as a minimum function, a maximum function, a count function, a sum function, a range function, an average function, a variance function, and the like.

According to an aspect of the disclosure, the satellite data source 110 adds a new dataset as a daily snapshot of an earth dynamics. In an example, the satellite data server 130 is triggered daily for example at midnight to download a dataset of temperature that is a daily snapshot of the earth temperature. The uncertainty component 150 can detect the missing data points and estimate the missing data points. Then, the indexing component 160 indexes the new dataset according to the spatial hierarchy to form a daily node in the daily layer 230.

Specifically, in an example to construct the daily node using aggregate quad tree structure, data points are sorted using a Z-order that maps two dimensional data points to one dimension. Then, the indexing component 160 uses the sorted data points as leaf nodes, and calculates aggregate nodes from the high resolution spatial layers to the low resolution spatial layers to build the aggregate quad tree for the daily node. For example, to compute aggregate values to be assigned to an aggregate node above leaf nodes, the indexing component 160 scans the four leaf nodes under the aggregate node, and calculates the aggregate values based on the four leaf nodes. To computer aggregate values to be assigned to an aggregate node above child aggregate nodes, the index component 160 scans the four child aggregate nodes and calculates the aggregate values based on the child aggregate nodes.

It is noted that the daily nodes 231-239 are generated in spatial hierarchy of the earth, thus the daily nodes 231-239 have the same aggregate quad tree structure.

According to an aspect of the disclosure, when daily nodes in one month are constructed, the daily nodes are merged to form a monthly node in the monthly layer 220. To merge the daily nodes, in an example, the indexing component 160 generates a monthly node having the aggregate quad tree structure as the daily nodes. Thus, each node in the monthly aggregate quad tree for a month has a corresponding node in each of the daily aggregate quad trees for days in the month. Further, the indexing component 160 assigns values on each node in the monthly aggregate quad tree based on corresponding nodes in the daily aggregate quad trees for the days in the month. In an example, values at the corresponding nodes in the daily aggregate quad trees for the days in February 2014 are sorted according to the dates in the February to form a list. Then, the list is assigned to the corresponding node in the monthly aggregate quad tree for February, 2014. In an example, when a query asking about all values at a specific location over a large time frame is received, a node corresponding to the specific location for the time frame can be accessed to retrieve the list of values.

Further, in the FIG. 1 example, the querying component 170 is configured to generate answers to queries based on the re-organized satellite data 140. In an embodiment, the querying component 170 can receive multiple types of queries, such as a spatio-temporal selection type query, an aggregate type of query and the like, and can generate answers based on the re-organized satellite data 140 in response to the queries efficiently.

In an embodiment, a user generates a spatio-temporal selection type query that specifies a parameter (e.g., temperature), a spatial range (e.g., a rectangle), and a temporal range (e.g., a start date and an end date). The querying component 170 provides a selection answer that includes all values of the parameter in the spatial range and the temporal range in response to the spatio-temporal selection type query. In an example, the querying component 170 uses a temporal filter and a spatial filter to generate the answer. The temporal filter examines the yearly nodes first to select yearly nodes that are completely in the temporal range. For a yearly node that is partially in the temporal range, the temporal filter examines the monthly nodes under the yearly node, and selects monthly nodes that are completely in the temporal range. For a monthly node that is partially in the temporal range, the temporal filter examines the daily nodes under the monthly node, and selects daily nodes that are in the temporal range.

It is noted that for a yearly node that is completely in the temporal range, the temporal filter does not need to examine the monthly nodes or the daily nodes. According to an aspect of the disclosure, the temporal filter selects a reduced total number of nodes comparing to a related filter that only examines daily nodes, and thus the query component 170 can have an improved query performance.

Further, in the example, the spatial filter then examines the aggregate quad tree in each of selected yearly nodes, monthly nodes and daily nodes. For an aggregate quad tree, the spatial filter starts from the root and goes deeper as needed until the leaf nodes. For an aggregate node in the aggregate quad tree, when the aggregate node is completely in the spatial range, the aggregate node is selected without going deeper. When the aggregate node is partially in the spatial range, the spatial filter examines the four child nodes of the aggregate node. Then, the values contained under each of the selected aggregate nodes and the leaf nodes are retrieved from the aggregate quad tree stored on disk. It is noted that all points contained under one node are guaranteed to be in a contiguously indexed as the points are kept sorted by the Z-order.

In another embodiment, a user can generate an aggregate query that specifies a parameter (e.g., temperature), a spatial range (e.g., a rectangle), and a temporal range (e.g., a start date and an end date). The querying component 170 generates an aggregate answer that includes a set of aggregate values, such as a minimum value, a maximum value, a count number, a sum and the like, based on all points in the spatial range and the temporal range. In an example, the querying component 170 uses the temporal filter and an aggregate computing component to generate the aggregate answer.

Similar to generating the selection answer, the temporal filter examines the yearly nodes first to select yearly nodes that are completely in the temporal range. For a yearly node that is partially in the temporal range, the temporal filter examines the monthly nodes under the yearly node, and selects monthly nodes that are completely in the temporal range. For a monthly node that is partially in the temporal range, the temporal filter examines the daily nodes under the monthly node, and selects daily nodes that are in the temporal range. According to an aspect of the disclosure, the temporal filter selects a reduced total number of nodes comparing to a related filter that only examines daily nodes, and the temporal filter can have an improved query performance.

The aggregate computing component then compute the aggregate values based on the aggregate quad trees at each of selected yearly nodes, monthly nodes and daily nodes. For an aggregate quad tree, the aggregate computing component starts from the root and goes deeper as needed until the leaf nodes. For an aggregate node in the aggregate quad tree, when the aggregate node is completely in the spatial range, the aggregate node is selected without going deeper. When the aggregate node is partially in the spatial range, the spatial filter examines the four child nodes of the aggregate node. Then, the aggregate values at the selected nodes are retrieved and aggregated to generate the aggregate answer.

According to an aspect of the disclosure, the visualization component 180 is configured to support multiple visualization options, such as images, videos, multi-level images, and the like. In an example, the visualization component 180 uses programming techniques, such as parallel processing, distributed computer cluster, and the like that can process large amount of data efficiently to visualize query answers.

In an embodiment, the visualization component 180 generates a heat map to visualize a query answer. For example, the heat map corresponds to a geographic map for the spatial range in the query, and values are represented as colors on the heat map. The heat map shows the distribution of values in the selected spatial range and temporal range. In an example, a heat map is generated for each day, and a plurality of heat maps are generated for a temporal range. Then, the plurality of heat maps are combined as a series of images to form a video to show changes over time.

In an example, the visualization component 180 uses MapReduce programming technique to generate the heat map. For example, the MapReduce programming technique includes a map function and a reduce function. The visualization component 180 uses the map function to partition the data for visualization using a uniform grid to generate cells and uses the reduce function to plot a heat map for each cell. For each cell, the visualization component 180 generates a cell heat map. In an example, the visualization component 180 scans in all points in the cell, and determines a color representation for each pixel in the cell heat map to represent a point in the cell. For example, the visualization component 180 uses a blue color to represent a smallest value and uses a red color to represent a largest value. In an example, if more than one points are map to the same pixel, the visualization component 180 can calculate an average of the points and determine a color to represent the average on the pixel. When the visualization component 180 generates all the cell heat maps, the visualization component 180 can suitably stitch the cell heat maps together to form a complete heat map.

In another embodiment, the visualization component 180 generates multi-level images for visualizing different regions and zoom levels. In an example, the visualization component 180 generates a three-level heat map image for temperature in an area of interests. The three-level heat map image includes a level-0 zoom which has the lowest resolution, a level-1 zoom which has the medium resolution and a level-2 zoom which has the highest resolution. In an example, at level-0 zoom, the whole area is represented as one image of 256×256 pixels; at level-1 zoom, the whole area is divided into four sub-areas, each of the sub-areas is represented as an image of 256×256 pixels; and at level-2 zoom, each of the sub-areas is divided into four child-areas, and each of the child-areas is represented as an image of 256×256 pixels.

In an embodiment, the visualization component 180 uses an algorithm of two steps to handle the exponentially increasing number of tiles/images per zoom level. The two steps include a partition step and a plot step. In the partition step, the visualization component 180 uses the map function to replicate each data point to all overlapping tiles. For example, a point can be replicate into a first tile in the level-0 zoom, a second tile in the level-1 zoom and a third tile in the level-2 zoom. In the plot step, the visualization component 180 uses the reduce function to take all points in each tile to generates a heat map for the tile as an image of 256×256 pixels. It is noted that the images do not need to be stitched together. In an example, the images can be stored separately in the memory circuitry 133.

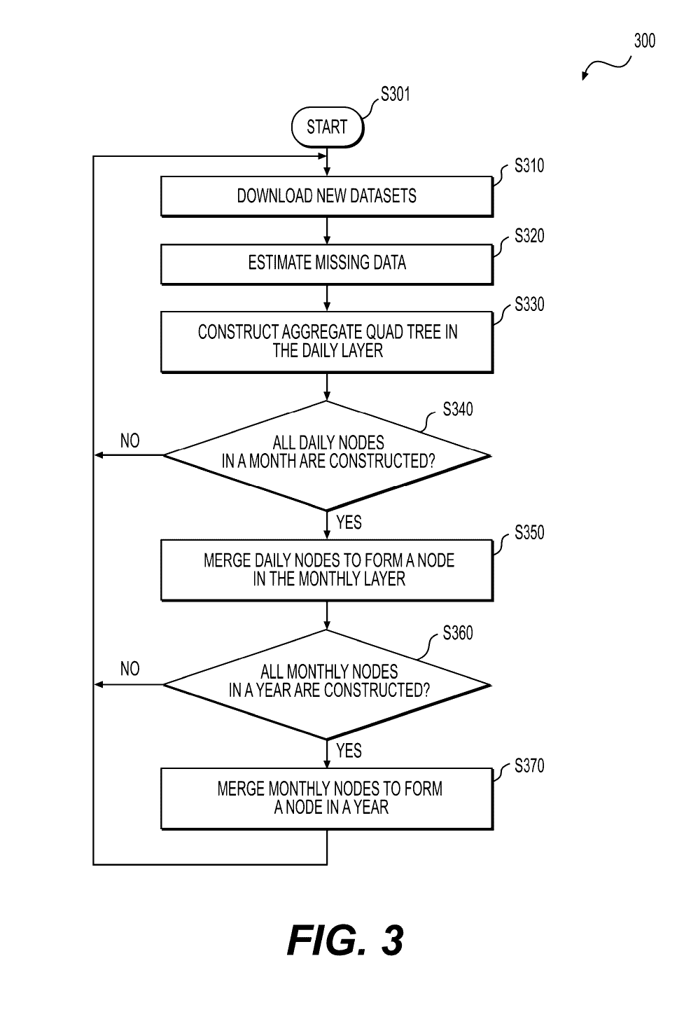

FIG. 3 shows a flow chart outlining a process example 300 according to an embodiment of the disclosure. In an example, the process 300 is executed by the satellite data server 130 to receive satellite data and organize satellite data according to an aggregate spatio-temporal index system, such as the aggregate spatio-temporal index system 200, and store the re-organized satellite data 140. The aggregate spatio-temporal index system uses a temporal hierarchy having multiple temporal layers, such as a daily layer, a monthly layer and a yearly layer, of different temporal resolution, and uses a spatial hierarchy having multiple spatial layers, such as a quad tree index, of different spatial resolution. The process starts at S301 and proceeds to S310.

At S310, a new dataset is downloaded. In an example, the satellite data source 110 adds new datasets as snapshots of the earth dynamics. For example, the satellite system measures temperature on the earth in the form of a daily snapshot of temperature on the earth with a suitable spatial resolution. The daily snapshot of temperature is stored at the satellite data source 110 as a dataset of temperature. The satellite system may measure other suitable parameters of earth dynamics at suitable temporal resolution and suitable spatial resolution. The measurements of the parameters can be suitably stored as datasets for the parameters in the satellite data source 110. In the example, the satellite data server 130 is triggered regularly, for example daily at midnight, to download new datasets for parameters, such as a dataset for daily snapshot of temperature of the day.

At S320, missing data is estimated. In an example, the processing circuitry 132 executes the software instructions for the uncertainty component 150 to estimate the missing data. For example, the uncertainty component 150 detects that the new dataset of temperature has a missing data point at a location, and uses a two-dimensional interpolation to generate an estimate value to fill in the dataset as the missing data point for the location. In an example, the uncertainty component 150 uses a linear interpolation function to calculate a first estimate based on two closest points on the same latitude as the missing data point, and uses a linear interpolation function to calculate a second estimate based on two closest points on the same longitude as the missing data point. Further, in the example, the uncertainty component 150 calculates an average of the first estimate and the second estimate, and uses the average as the final estimate for the missing data point. In another example, when one of the first estimate and the second estimate is not available, the uncertainty component 150 uses the other estimate as the final estimate for the missing point.

At 5330, an aggregate quad tree is generated based on the new dataset. In an example, the indexing component 160 builds the aggregate quad tree according to the spatial hierarchy of the aggregate spatio-temporal index system 200, and assigns the aggregate quad tree as a node in the daily layer 230 of the aggregate spatio-temporal index system 200. The spatial hierarchy includes multiple spatial layers of different resolution. In an embodiment, the aggregate quad tree is built by recursively subdividing a two-dimensional space into four quadrants or regions until the partitions have the spatial resolution as the data points in the satellite data. In an example, the spatial hierarchy has a root layer. The root layer includes a root node corresponding to the whole spatial area of interests, such as the earth. The spatial area is divided into four quadrant partitions. The spatial hierarchy includes a first spatial layer under the root layer. The first spatial layer includes four nodes corresponding to the four quadrant partitions. The partitions are further divided to form next spatial layer of higher resolution until the partitions have the same resolution as the data points of the dataset. The spatial hierarchy then includes a leaf layer having leaf nodes corresponding to the data points in the dataset.

For the aggregate quad tree structure, data points in the dataset are sorted using a Z-order that maps two dimensional data points to one dimension. Then, the indexing component 160 uses the sorted data points as the leaf nodes, and calculates aggregate nodes from the high resolution spatial layers to the low resolution spatial layers to build the aggregate quad tree. For example, to compute aggregate values to be assigned to an aggregate node above leaf nodes, the indexing component 160 scans the four leaf nodes under the aggregate node, and calculates the aggregate values based on the four leaf nodes. To computer aggregate values to be assigned to an aggregate node above child aggregate nodes, the index component 160 scans the four child aggregate nodes and calculates the aggregate values based on the child aggregate node. In an example, each aggregate node is assigned with aggregate values that summarize nodes under the aggregate node. The aggregate values are calculated according to aggregate functions, such as by a minimum function, a maximum function, a count function, a sum function, a range function, an average function, a variance function, and the like.

Then, in an example, the constructed aggregate quad tree is assigned to a new daily node in the temporal layer 230 of the aggregate spatio-temporal index system 200. The re-organized satellite data 140 is updated with the new daily node.

At S340, the satellite data server 130 determines whether all the daily nodes for a monthly node are constructed. When all the daily nodes for a monthly node are constructed, the process proceeds to S350; otherwise, the process returns to S310.

At S350, the daily nodes are merged to generate an aggregate quad tree to be assigned to a monthly node in the monthly layer. To merge the daily nodes, in an example, the indexing component 160 generates a monthly node having the aggregate quad tree structure as the daily nodes. Thus, each node in the monthly aggregate quad tree for a month has a corresponding node in each of the daily aggregate quad trees for days in the month. Further, the indexing component 160 assigns values on each node in the monthly aggregate quad tree based on corresponding nodes in the daily aggregate quad trees for the days in the month. In an example, values at the corresponding nodes in the daily aggregate quad trees for the days in February 2014 are sorted according to the dates in the February to form a list. Then, the list is assigned to the corresponding node in the monthly aggregate quad tree for February, 2014. The re-organized satellite data 140 is updated with the new monthly node.

At S360, the satellite data server 130 determines whether all the monthly nodes for a yearly node are constructed. When all the monthly nodes for a yearly node are constructed, the process proceeds to S370; otherwise, the process returns to S310.

At S370, the monthly nodes are merged to generate an aggregate quad tree to be assigned to a yearly node in the monthly layer. To merge the monthly nodes, in an example, the indexing component 160 generates a yearly node having the aggregate quad tree structure as the monthly nodes. Thus, each node in the yearly aggregate quad tree for a year has a corresponding node in each of the monthly aggregate quad trees for months in the year. Further, the indexing component 160 assigns values on each node in the yearly aggregate quad tree based on corresponding nodes in the monthly aggregate quad trees for the months in the year. In an example, values at the corresponding nodes in the monthly aggregate quad trees for the months in 2013 are sorted according to the months in 2013 to form a list. Then, the list is assigned to the corresponding node in the yearly aggregate quad tree for 2013. The re-organized satellite data 140 is updated with the new yearly node. Then the process returns to S310.

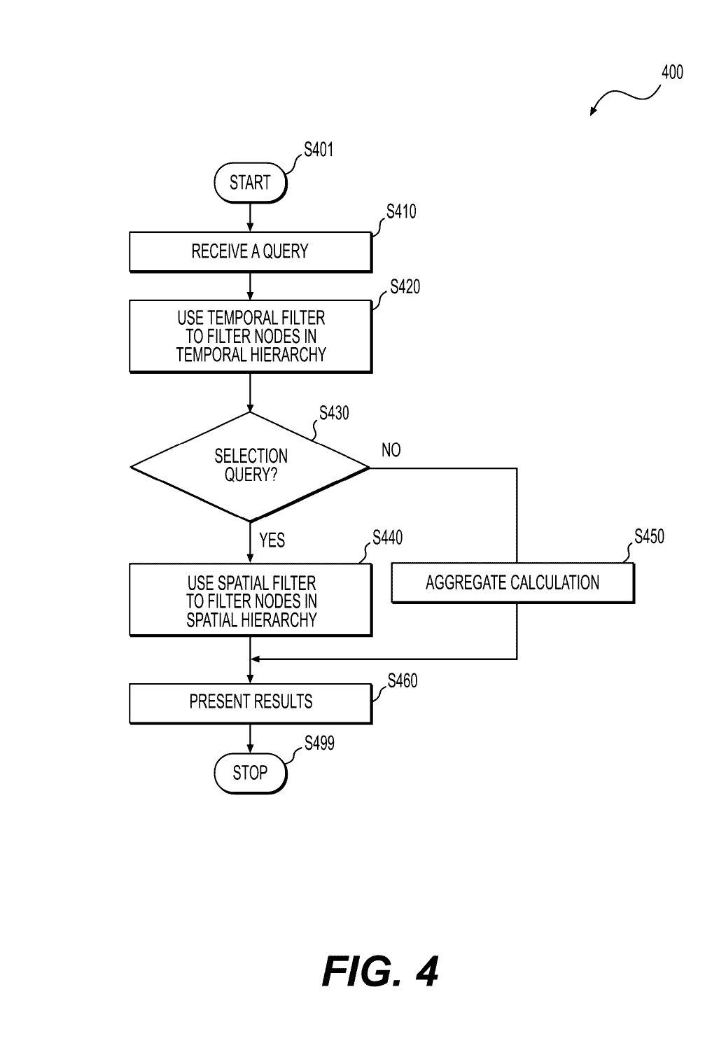

FIG. 4 shows a flow chart outlining a process example 400 to generate an answer in response to a query according to an embodiment of the disclosure. In an example, the process 400 is executed by the satellite data server 130. The satellite data server 130 stores the re-organized satellite data 140 that is organized according to the aggregate spatio-temporal index system and generates answer in response to a query based on the re-organized satellite data 140. The query generally specifies a parameter (e.g., temperature), a spatial range (e.g., a rectangle), and a temporal range (e.g., a start date and an end date). When the query is a spatio-temporal selection type query, the satellite data server 130 selects satellite data for the parameter in the spatial range and the temporal range, and provides the selected satellite data as the answer. When the query is an aggregate type of query, the satellite data server 130 provides aggregate values for satellite data of the parameter in the spatial range and the temporal range as the answer. The process starts at S401 and proceeds to S410.

At S410, a query is received. In an example, a client device, such as the client device 121, and the like executes client software instructions to provide a graphic user interface for a user. The user generates a query via the graphic user interface. The query is sent to the satellite data server 130 via the network 101.

At S420, a temporal filter is used to filter partitions (e.g., nodes) in the temporal hierarchy by different temporal layers. In an embodiment, the querying component 170 uses the temporal filter to examine the yearly nodes first to select yearly nodes that are completely in the temporal range. For a yearly node that is partially in the temporal range, the temporal filter examines the monthly nodes under the yearly node, and selects monthly nodes that are completely in the temporal range. For a monthly node that is partially in the temporal range, the temporal filter examines the daily nodes under the monthly node, and selects daily nodes that are in the temporal range.

It is noted that for a yearly node that is completely in the temporal range, the temporal filter does not need to examine the monthly nodes or the daily nodes. According to an aspect of the disclosure, the temporal filter selects a reduced total number of nodes comparing to a related filter that only examines daily nodes, and thus the query component 170 can have an improved query performance.

At 5430, the satellite data server 130 determines whether the query is a selection query. When the query is a selection query, the process proceeds to S440; when the query is not a selection query but an aggregate query, the process proceeds to S450.

At S440, a spatial filter is used to filter nodes in the spatial hierarchy. In an example, the querying component 170 uses the spatial filter to examine the aggregate quad tree in each of selected yearly nodes, monthly nodes and daily nodes. For an aggregate quad tree, the spatial filter starts from the root and goes deeper as needed until the leaf nodes. For an aggregate node in the aggregate quad tree, when the aggregate node is completely in the spatial range, the aggregate node is selected without going deeper. When the aggregate node is partially in the spatial range, the spatial filter examines the four child nodes of the aggregate node. Then, the values contained under each of the selected aggregate nodes and the leaf nodes are retrieved from the aggregate quad tree stored on disk. It is noted that, in an example, data points contained under one node are contiguously indexed because the points are kept sorted by the Z-order, and the data points are stored in the memory circuitry 133 according to indexes. Thus, access to data points under one node can be achieved by one memory access in an example.

At S450, aggregate values are calculated based on the spatial hierarchy. In an example, the querying component 170 uses an aggregate computing component to compute the aggregate values based on the aggregate quad trees at each of selected yearly nodes, monthly nodes and daily nodes. For an aggregate quad tree, the aggregate computing component starts from the root and goes deeper as needed until the leaf nodes. For an aggregate node in the aggregate quad tree, when the aggregate node is completely in the spatial range, the aggregate node is selected without going deeper. When the aggregate node is partially in the spatial range, the spatial filter examines the four child nodes of the aggregate node. Then, the aggregate values at the selected nodes are retrieved and aggregated to generate the aggregate answer.

At S460, the query results are presented. In an example, the visualization component 180 generates visual medium to present the answer to the query. The visualization component 180 is configured to support multiple visualization options, such as images, videos, multi-level images, and the like. In an example, the visualization component 180 uses programming techniques, such as parallel processing, distributed computer cluster, and the like that can process large amount of data efficiently to visualize query answers. Further, in an example, the web service component 190 can generate web pages to carry the visual medium. The web pages can be sent to and displayed by the client device to show the results to the user. The process proceeds to S499 and terminates.

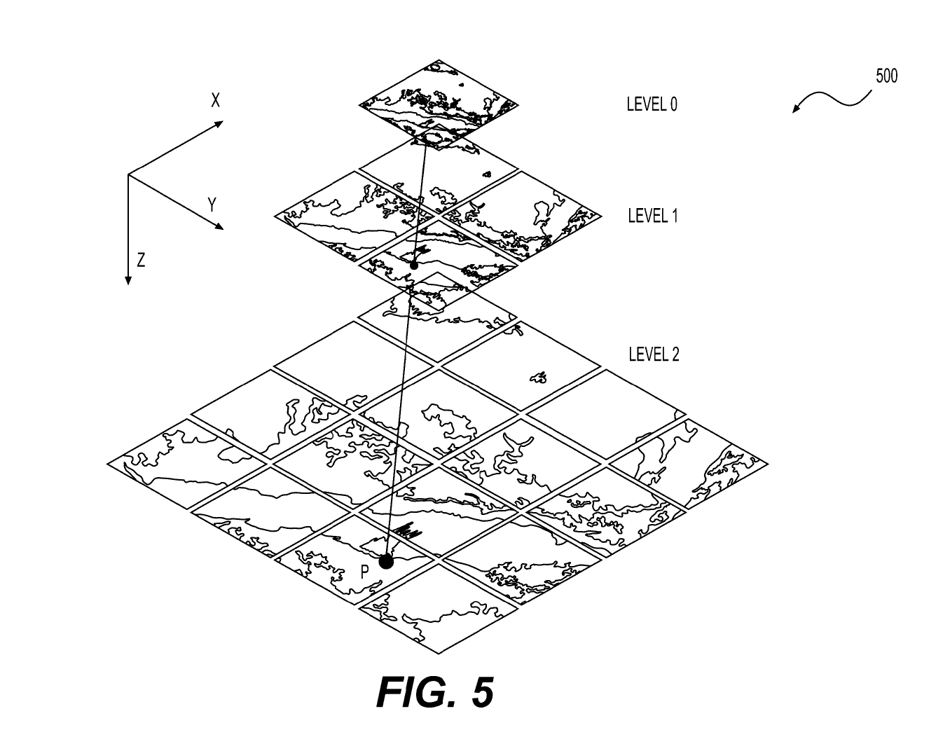

FIG. 5 shows an example of three-level images 500 according to an embodiment of the disclosure. The three-level images 500 include a level-0 zoom which has the lowest resolution, a level-1 zoom which has the medium resolution and a level-2 zoom which has the highest resolution. In an example, at level-0 zoom, the whole area is represented as one image of 256×256 pixels; at level-1 zoom, the whole area is divided into four sub-areas, each of the sub-areas is represented as an image of 256×256 pixels; and at level-2 zoom, each of the sub-areas is divided into four child-areas, and each of the child-areas is represented as an image of 256×256 pixels.

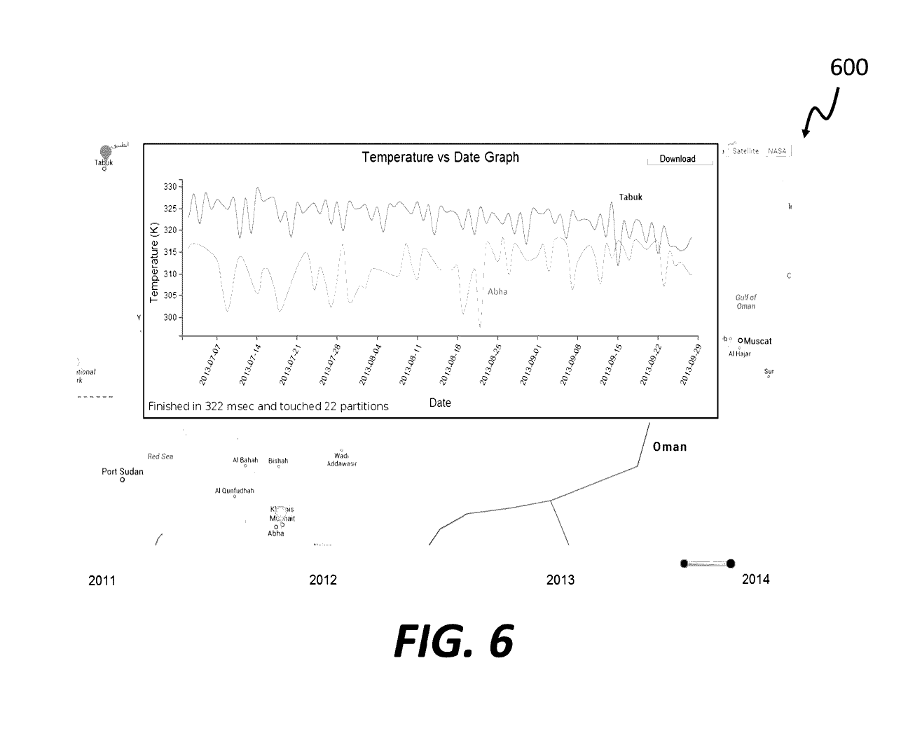

FIG. 6 shows a graphic user interface (GUI) 600 according to an embodiment of the disclosure. The GUI 600 displays an interactive map based on a map system, such as Google Maps. The GUI 600 can provide, for example on the top right, a map selector where the user can switch between map view, satellite view, and heat map view. Further, the GUI 600 can provide a toolbar (not shown) with a search box, date selector, and dataset selector. The GUI 600 can also provide a button (not shown) to select exporting an image or exporting a video.

In the FIG. 6 example, a selection query is generated by a user to select all values at two distinct locations over a period of three months. The answer to the selection query is displayed as a chart “Temperature vs Data Graph” in the GUI 600. The chart compares the temperatures at the two selected locations. The chart has a download button to allow the user to download the answer as, for example, a CSV file to be used in another application.

In addition to point queries, users can also specify spatial ranges. In an example, the satellite data server 130 can return minimum, maximum, and average temperature in the given spatial ranges for each day in the selected time period or return an average for the whole selected spatial range and temporal range. In another example, the satellite data server 130 can return some statistic about the query such as total running time and number of partitions processed to answer the query.

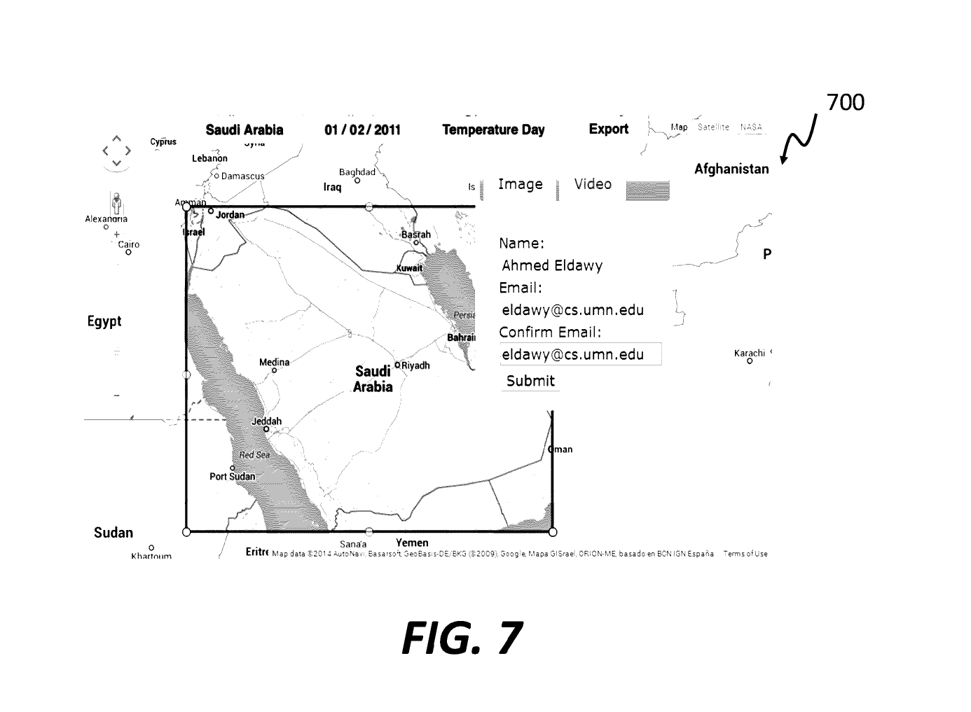

FIG. 7 shows a graphic user interface (GUI) 700 for a user to generate heat maps according to an embodiment of the disclosure. The user can generate a query via the GUI 700. The query specifies a spatial range on the map, a dataset (e.g., temperature) and either a specific date for image, or a start and end dates for a video. In the FIG. 7 example, the user can enter an email address to which the generated image or video will be sent to. In an example, when the satellite data server 130 generates the answer to the query, an email is sent to the user-provided email address with a link to download either the image or the video. In addition, in an example, the satellite data server 130 can generate a file of Keyhole Markup Language (KML) format to preview the generated image on Goggle Earth or a similar application.

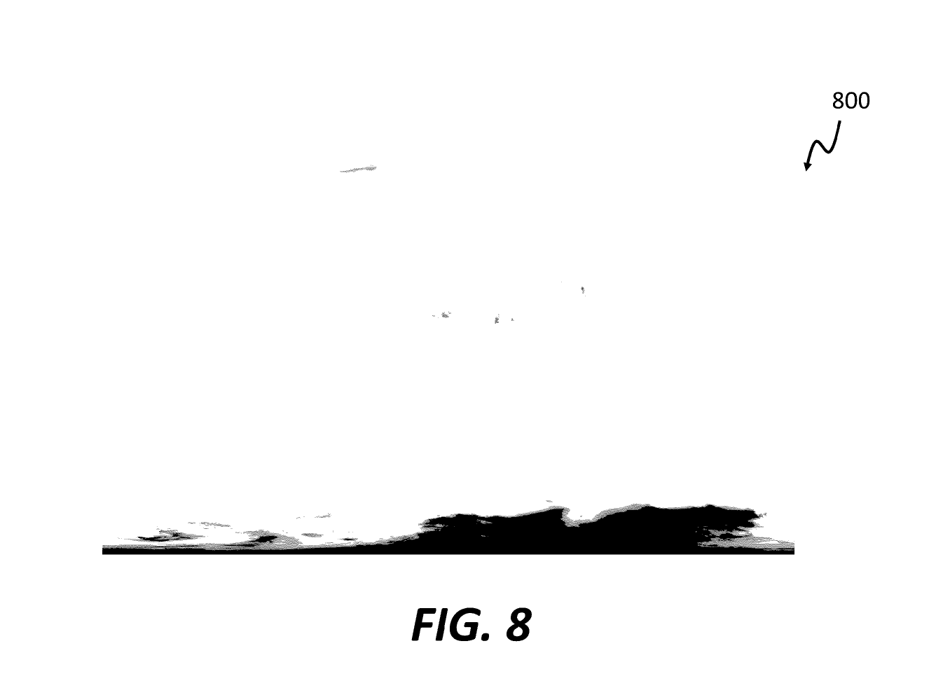

FIG. 8 shows a heat map 800 generated by the satellite data server 130 according to an embodiment of the disclosure. The heat map 800 shows the temperature on Apr. 8, 2014 for the whole world generated from more than 300 files containing around 450 million points. The resolution of this image is about 8000×4000 pixels and it took around five minutes to generate. Missing data is recovered in this image to give a smooth image that covers all land areas.

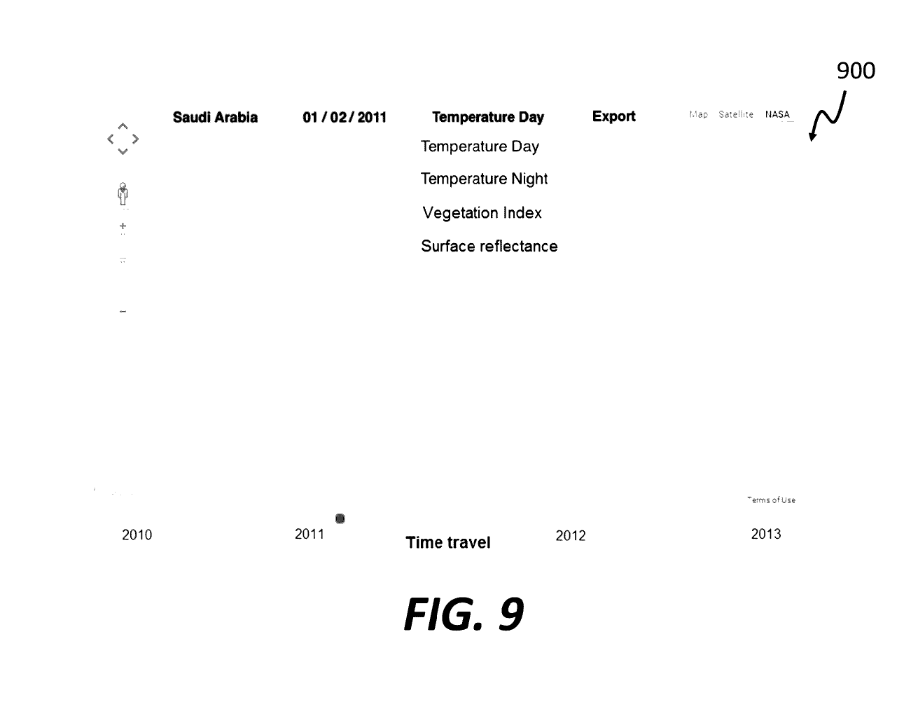

FIG. 9 shows a graphic user interface (GUI) 900 according to an embodiment of the disclosure. The GUI 900 displays an interactive heat map for the selected date and dataset to make it easier for users to explore the data. In an example, the interactive heat map is based on Google Maps and the interactive heat map provides navigation experience, such as pan and zoom. The GUI 900 shows a tool bar to select the visible area (e.g., Saudi Arabia), the date (e.g., Jan. 2, 2011), the dataset (e.g., Temperature Day), and the like. The user can use the tool bar to change the visible area, the date, the dataset, and the like. In an example, the satellite data server 130 can generate multi-level heat maps that form a pyramid of images. When the visible area changes in the tool bar, the web page can load the corresponding set of images from the pyramid in response to the visible area change in the tool bar.

When implemented in hardware, the hardware may comprise one or more of discrete components, an integrated circuit, an application-specific integrated circuit (ASIC), etc.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method of satellite data service, comprising:
receiving a dataset of values that are measurements of a parameter at a temporal point for locations on the earth;
organizing, via processing circuitry, the values according to spatial layers in an aggregate spatio-temporal index system to form an aggregate tree associated with the temporal point; and
updating temporal layers in the aggregate spatio-temporal index system in response to the aggregate tree.

2. The method of claim 1, wherein receiving the dataset of values that are the measurements of the parameters at the temporal point for the locations on the earth further comprises:
estimating a missing value for a location in the dataset based on values of other locations.

3. The method of claim 1, wherein estimating the missing value for the location in the database further comprises:
calculating a first estimate for the location based on first values of first other locations aligned with the location in a first dimension;
calculating a second estimate for the location based on second values of second other locations aligned with the location in a second dimension; and
combining the first estimate and the second estimate to calculate the missing value.

4. The method of claim 1, wherein organizing the values according to the spatial layers in the aggregate spatio-temporal index system to form the aggregate tree associated with the temporal point comprises:
organizing the values as leaf nodes in the aggregate tree that uses a quad tree data structure for indexing a two-dimensional space; and
assigning aggregated values from child nodes of each aggregate node to the aggregate node.

5. The method of claim 1, wherein updating the temporal layers in the aggregate spatio-temporal index system in response to the aggregate tree further comprises:
adding the aggregate tree as a daily node in a daily layer of the aggregate spatio-temporal index system.

6. The method of claim 5, further comprising:
adding a monthly aggregate tree as a monthly node in a monthly layer of the aggregate spatio-temporal index system to aggregate daily nodes in a month when the daily nodes in the month are complete.

7. The method of claim 6, further comprising:
adding a yearly aggregate tree as a yearly node in a yearly layer of the aggregate spatio-temporal index system to aggregate monthly nodes in a year when the monthly nodes of the year are complete.

8. A method of satellite data service, comprising:
storing satellite datasets of values that are measurements of a parameter over time for locations on the earth according to an aggregate spatio-temporal index system with aggregate nodes that aggregate the satellite datasets in temporal layers and spatial layers;
receiving a query specifying the parameter, a temporal range and a spatial range;
filtering, via processing circuitry, according to the aggregate spatio-temporal index system, in the temporal layers and the spatial layers to select aggregate nodes; and
generating an answer to the query based on the selected aggregate nodes.

9. The method of claim 8, wherein storing the satellite datasets of values that are measurements of the parameter over time for the locations on the earth according to the aggregate spatio-temporal index system with the aggregate nodes that aggregate the satellite datasets in the temporal layers and the spatial layers further comprises:
storing a dataset of values for the parameter associated with a temporal point as leaf nodes in an aggregate tree that uses a quad tree data structure for indexing a two-dimensional space.

10. The method of claim 9, further comprising:
storing the aggregate tree associated with the temporal point as a daily node in a daily layer of the aggregate spatio-temporal index system.

11. The method of claim 10, further comprising:
storing a monthly aggregate tree as a monthly node in a monthly layer of the aggregate spatio-temporal index system to aggregate daily nodes in a month.

12. The method of claim 11, further comprising:
storing a yearly aggregate tree as a yearly node in a yearly layer of the aggregate spatio-temporal index system to aggregate monthly nodes in a year.

13. The method of claim 8, wherein filtering, according to the aggregate spatio-temporal index system, in the temporal layers and the spatial layers to select the aggregate nodes further comprises:
filtering by the temporal layers to select aggregate trees that are in the temporal range;
filtering by the spatial layers to select values in the aggregate trees that are in the spatial range; and
forming the answer to the query from the selected values.

14. The method of claim 8, wherein filtering, according to the aggregate spatio-temporal index system, in the temporal layers and the spatial layers to select the aggregate nodes further comprises:
filtering by the temporal layers to select aggregate trees that are in the temporal range;
filtering by the spatial layers to select aggregate nodes that are in the temporal range; and
aggregating the selected aggregate nodes to form the answer to the query.

15. A satellite data server system, comprising:
memory circuitry configured to store satellite data for a parameter according to an aggregate spatio-temporal index system; and
processing circuitry configured to receive a dataset of values that are measurements of the parameter at a temporal point for locations on the earth, organize the values according to spatial layers in the aggregate spatio-temporal index system to form an aggregate tree associated with the temporal point, and update temporal layers in the aggregate spatio-temporal index system to add the aggregate tree in the stored satellite data.

16. The satellite data server system of claim 15, wherein the processing circuitry is configured to estimate a missing value for a location in the dataset based on values of other locations.

17. The satellite data server system of claim 15, wherein the processing circuitry is configured to calculate a first estimate for the location based on first values of first other locations aligned with the location in a first dimension, calculate a second estimate for the location based on second values of second other locations aligned with the location in a second dimension and combine the first estimate and the second estimate to calculate the missing value.

18. The satellite data server system of claim 15, wherein the processing circuitry is configured to organize the values as leaf nodes in the aggregate tree that uses a quad tree data structure for indexing a two-dimensional space and assign aggregated values from child nodes of each aggregate node to the aggregate node.

19. The satellite data server system of claim 15, wherein the processing circuitry is configured to add the aggregate tree as a daily node in a daily layer of the aggregate spatio-temporal index system.

20. The satellite data server system of claim 19, wherein the processing circuitry is configured to add a monthly aggregate tree as a monthly node in a monthly layer of the aggregate spatio-temporal index system to aggregate daily nodes in a month when the daily nodes of the month are complete, and add a yearly aggregate tree as a yearly node in a yearly layer of the aggregate spatio-temporal index system to aggregate monthly nodes in a year when the monthly nodes are complete.
